(19) United States
(12) Patent Application Publication
(10) Pub. No.: US 2009/0167666 A1
(43) Pub. Date: Jul. 2, 2009

(54) LCD Driver IC and Method for Operating the Same

(76) Inventor: Kyung Won MIN, Ansan-si (KR)

Correspondence Address: THE LAW OFFICES OF ANDREW D. FORTNEY, PH.D., P.C., 401 W FALLBROOK AVE STE 204, FRESNO, CA, 93711-5835, US

(21) Appl. No.: 12/343,180

(22) Filed: Dec. 23, 2008

(30) Foreign Application Priority Data
Dec. 27, 2007 (KR) 10-2007-0139213

(51) Int. Cl. G09G 3/36

(52) U.S. Cl. 345/94; 345/98

(57) ABSTRACT

A LCD driver IC includes an operational amplifier configured to remove or reduce an offset voltage level by outputting offset voltages having different polarities according to a state of a clock while going through one frame.

The present application claims priority under 35 U.S.C. § 119 to Korean Patent Application No. 10-2007-0139213 (filed Dec. 27, 2007), which is hereby incorporated by reference in its entirety.

### BACKGROUND

### Description of the Related Art

Embodiments of the present invention relate to a liquid crystal display (LCD) driver IC and a method for operating the same.

With a conventional auto-zero offset voltage removal method, a voltage from an output terminal is compared with that from an input terminal to store a voltage difference therebetween in a capacitor and apply the voltage difference to the input terminal again, thereby controlling offset voltage.

FIG. 1A shows a circuit for removing offset voltage, and FIG. 1B shows a timing diagram. Here, c represents an offset holding capacitor, and OA represents an operational amplifier (OPAMP).

Referring now to FIG. 1B, during a first stage of operation (1), switch 1 (SW1) and switch 3 (SW3; see FIG. 1A) are turned on, and switch 2 (SW2) is turned off. In this state, charges stored in the capacitor c are initialized and/or equalized.

Referring again to FIG. 1B, during a second stage of operation (2), switch 1 (SW1 in FIG. 1A) is turned off, and switches 2 and 3 (SW2 and SW3) are turned on. In this state, a voltage difference between Vout and Vin stores charges in the capacitor c.

Finally, referring back to FIG. 1B, during a third stage of operation (3), as switch 1 (SW1 in FIG. 1A) is turned on and switches 2 and 3 (SW2 and SW3) are turned off, charges stored in the capacitor c are applied to an input terminal of the OPAMP OA to finally remove the offset voltages between the input terminal Vin and the output terminal Vout.

However, the related art switch-capacitor circuit has disadvantages in that the chip area is relatively large, and high-speed operation is limited due to the relatively large capacitor charging period.

Also, with the related art, the correction voltage stored in the capacitor may change due to leakage from a switch junction and a sub-threshold region which has a disadvantage in that periodic refreshing is needed.

### SUMMARY OF THE INVENTION

In order to drive a large resistor and a capacitor, a buffer having a high current drive capacity and a high-speed OPAMP having a miniaturized chip area are beneficial. In particular, since the offset voltage of the OPAMP in an output buffer (or at a terminal thereof) may drive many channels, the OPAMP may have an offset voltage greater than a reference value, which may cause errors in the output voltage.

The output voltage of the amplifier thereby outputs a voltage level different from a certain gray scale. Therefore, a problem arises in that black or white stripes may be shown on a display screen of a thin film transistor (TFT) LCD, ultimately degrading the quality of the display. In order to solve this problem, embodiments of the present invention provide a LCD driver IC capable of correcting such offsets easily and a method for operating the same.

A LCD driver IC according to embodiments of the present invention may include an OPAMP removing an offset voltage level by outputting an offset voltage having different polarities according to a state of a clock while going through one frame.

Also, a method for operating a LCD driver IC according to embodiments of the present invention may include removing or reducing an offset voltage level in an OPAMP by outputting an offset voltage having different polarities according to a state of a clock while going through one frame.

### BRIEF DESCRIPTION OF THE DRAWINGS

FIG. 1A is a schematic of an exemplary circuit for removing a conventional offset voltage, and FIG. 1B is a timing diagram associated with exemplary operations of the circuit of FIG. 1A;

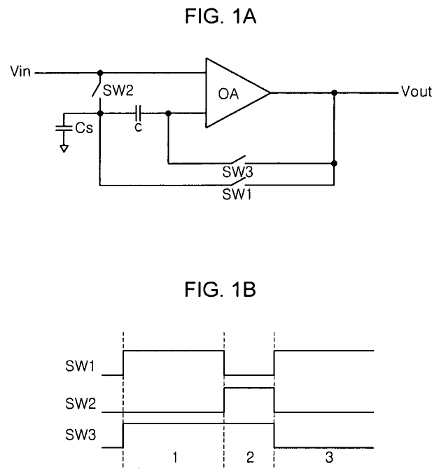

FIG. 2 is a configuration view of a TFT-LCD to which an exemplary LCD driver IC can be applied;

FIGS. 3(A)-(B) include diagrams of circuits for an exemplary offset removal method in a LCD driver IC, and FIG. 3(C) shows exemplary waveforms associated with the exemplary method;

FIG. 4 is a schematic diagram of an exemplary folded cascade OPAMP that uses an offset correction method according to one or more embodiments of the present invention; and

FIG. 5 shows the results of simulating an exemplary circuit having a folded cascade OPAMP that uses an embodiment of the present offset correction method.

### DETAILED DESCRIPTION OF THE EMBODIMENTS

Hereinafter, a LCD driver IC and a method for operating the same according to embodiments of the present invention will be described with reference to the accompanying drawings.

In the description of the following embodiments, it will be understood that when a layer (or film) is referred to as being ‘on’ another layer or substrate, it can be directly on another layer or substrate, or one or more intervening layers may also be present. Further, it will be understood that when a layer is referred to as being ‘under’ another layer, it can be directly under another layer, or one or more intervening layers may also be present. In addition, it will also be understood that when a layer is referred to as being ‘between’ two layers, it can be the only layer between the two layers, or one or more intervening layers may also be present.

Hereinafter, a LCD driver IC and a method for operating the same according to embodiments of the present invention will be described with reference to the accompanying drawings. The following describes an exemplary operational amplifier (OPAMP) for low-offset source driver IC, but the present invention is not limited thereto.

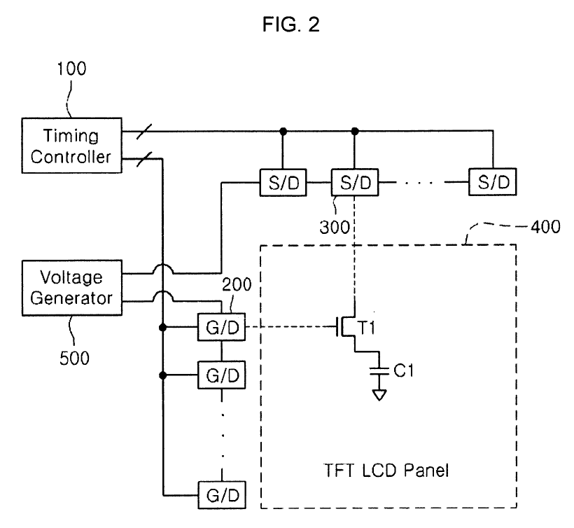

FIG. 2 is a configuration view of a TFT-LCD to which a LCD driver IC according to embodiments of the present invention can be applied, but the TFT-LCD to which the embodiments can be applied is not limited to the configuration of FIG. 2.

Referring to FIG. 2, a TFT-LCD may include a plurality of gate drivers 200 driven by a timing controller 100 to drive gate lines of a liquid crystal panel 400 sequentially, a plurality of source drivers 300 driven by the timing controller 100 to drive source lines of the liquid crystal panel 400 and to allow the liquid crystal panel 400 to display data, and a voltage generator 500 generating various voltages for the system.

In the liquid crystal panel 400, unit pixels consisting of a liquid crystal capacitor C1 and a switching thin film transistor T1 may be arranged in a matrix in a display, wherein a source of the thin film transistor T1 is connected to a source line driven by the source driver 300, and a gate of the thin film transistor T1 is connected to a gate line drive by a gate driver 200.

The TFT-LCD may drive one gate line corresponding to the gate driver 200 sequentially through the timing controller 100, and the source driver 300 may input data provided from the timing controller 100 in the form of an analog signal on the source line, thereby displaying the data.

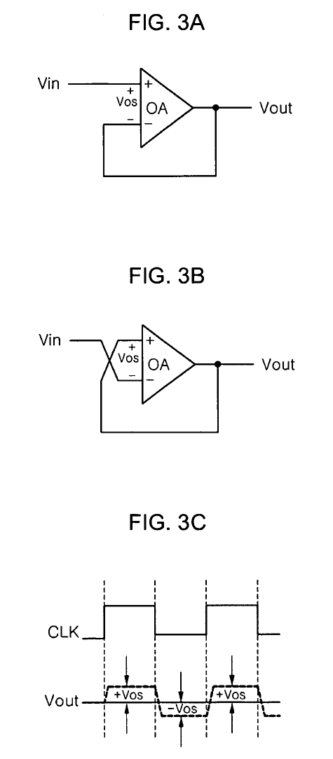

FIGS. 3(A)-(B) show circuits for an offset removal method in a LCD driver IC according to embodiments of the present invention.

Generally, offset occurs due to mismatch of processes when manufacturing a device. The mismatch may occur due to the width-length (W/L) ratio of a MOS transistor, or differences in an ion-implantation step or a photolithography step at the time of manufacturing. It is difficult to reliably make the offset voltage (Vos) zero, even if the process is very strictly controlled. However, embodiments of the present invention can remove the offset through the following principle.

The basic principle of the exemplary offset voltage correction circuit shown in FIGS. 3(A)-(B) is as follows. When a clock signal CLK is high as shown in FIG. 3(C), a voltage level Vout plus Vos is output by the circuit of FIG. 3(A), and when the clock signal CLK is low as shown in FIG. 3(C), a voltage level of Vout minus Vos is output by the circuit of FIG. 3(B), due to an effective crossing of the input terminals to the operational amplifier OA. Offset voltage levels having different polarities may be output while going through one frame or one period as shown in FIG. 3 (C), making it possible to remove or reduce the offset voltage.

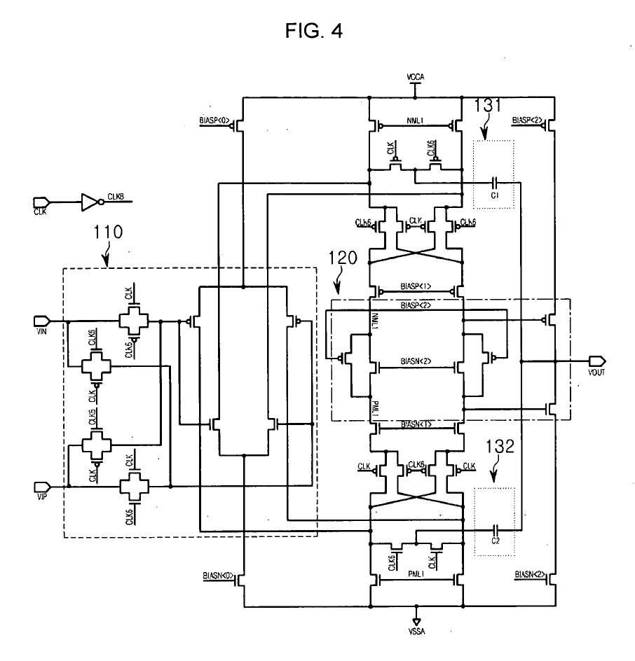

FIG. 4 is a schematic diagram of an exemplary folded cascade OPAMP that implements an offset correction method according to embodiments of the present invention.

As shown in FIG. 4, in order to reduce a constant current, and instead obtain a rail-to-rail input range, an OPAMP may be designed using a modified rail-to-rail structure, without using an independent differential amplifier. The operational amplifier may include an AB grade output terminal, in order to supply a large operational range and/or have a small constant current to the output terminal.

A rail-to-rail input terminal 110 may have both PMOS and NMOS input terminals. A class AB structure output terminal 120 may comprise a summing circuit in an intermediate terminal which is biased by floating current sources, BIASP<2> and BIASN<2>, making it possible to supply a predetermined current irrespective of bias current from the input terminal.

Two input pairs of differential mode input terminals may be connected to an output of the OPAMP to form a single gain OPAMP. Also, the OPAMP may use a Miller correction circuit including capacitors 131 and 132.

As shown in FIG. 4, embodiments of the present invention may use a method to switch a drain terminal which has an advantage in that the OPAMP is insensitive to noise. The exemplary OPAMP of FIG. 4 follows the operation of the offset correction circuit and changes the offset polarities according to received clock signal, making it possible to correct the offset.

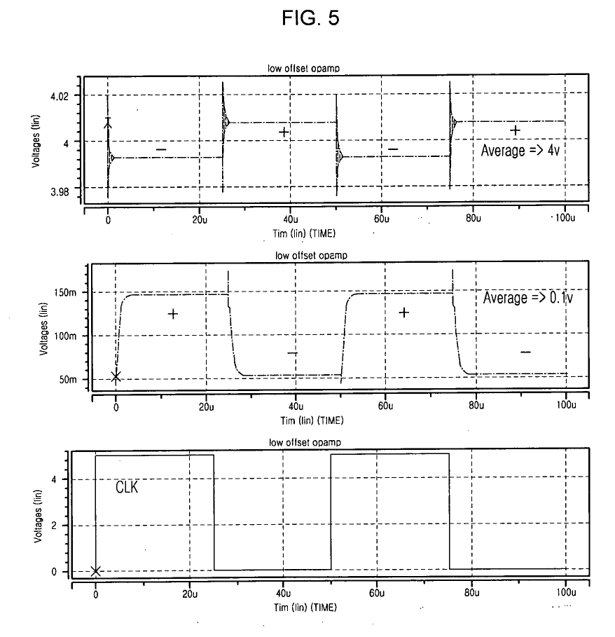

FIG. 5 is a result of simulating an exemplary circuit having a folded cascade OPAMP that implements the offset correction method of various embodiments of the invention. The offset voltage may be set in the input pairs, and the offset voltage may be returned to its original voltage level passing through one frame or one clock, such that the offset is corrected.

The LCD driver IC and the method for operating the same may output offset voltages having different polarities according to the received clock level while going through one frame, thereby removing or reducing the offset voltage level. Also, embodiments of the present invention may use a method to switch the drain terminal, which has an advantage in that the OPAMP is insensitive to noise.

Any reference in this specification to “one embodiment,” “an embodiment,” “exemplary embodiment(s),” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is within the purview of one skilled in the art to effect such feature, structure, or characteristic in connection with other embodiments.

Although embodiments of the present invention have been described with reference to a number of illustrative embodiments thereof, it should be understood that numerous other modifications and embodiments can be devised by those skilled in the art that will fall within the spirit and scope of the principles of this disclosure. More particularly, variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A LCD driver IC comprising:
an operational amplifier configured to remove or reduce an offset voltage level by outputting an offset voltage having different polarities according to a state of a clock while going through one frame.

2. The LCD driver IC according to claim 1, wherein the operational amplifier comprises:
a rail-to-rail input terminal having PMOS and NMOS input terminals; and
a class AB output terminal.

3. The LCD driver IC according to claim 2, wherein the class AB output terminal comprises a summing circuit biased by floating current sources.

4. The LCD driver IC according to claim 3, wherein the class AB output terminal is configured to supply a predetermined current irrespective of a bias current from the input terminal.

5. The LCD driver IC according to claim 1, wherein the output terminal comprises two pairs of differential mode input terminals connected to an output of the operational amplifier.

6. The LCD driver IC according to claim 5, wherein the operational amplifier forms a single gain operational amplifier.

7. The LCD driver IC according to claim 2, wherein the output terminal comprises two pairs of differential mode input terminals connected to an output of the operational amplifier.

8. The LCD driver IC according to claim 7, wherein the operational amplifier forms a single gain operational amplifier.

9. The LCD driver IC according to claim 2, wherein the includes operational amplifier a Miller correction circuit.

10. The LCD driver IC according to claim 1, wherein the operational amplifier switches a drain terminal to be insensitive to noise.

11. A method for operating a LCD driver IC comprising:
removing an offset voltage level by outputting an offset voltage having different polarities according to a state of a clock while going through one frame.

12. The method according to claim 11, wherein when a clock signal CLK is high, an operational amplifier in the LCD driver IC outputs a voltage level of Vout plus the offset voltage (Vos).

13. The method according to claim 12, wherein when a clock signal CLK is low, an operational amplifier in the LCD driver IC outputs a voltage level of Vout minus the offset voltage (Vos).

14. The method according to claim 13, wherein the voltage level is output due to effective crossing of input terminals in the operational amplifier.

15. The method according to claim 11, wherein when a clock signal CLK is low, an operational amplifier in the LCD driver IC outputs a voltage level of Vout minus the offset voltage (Vos).

16. The method according to claim 11, wherein the operational amplifier switches a drain terminal.

17. The method according to claim 16, wherein the operational amplifier is insensitive to noise.
